(19) United States
(12) Patent Application Publication
(10) Pub. No.: US 2014/0211473 A1
(43) Pub. Date: Jul. 31, 2014

(54) OPTICAL COMPONENT, METHOD AND APPLICATION

(71) Applicants: Matthew Weidman, Orlando, FL (US); Martin Richardson, Geneva, FL (US)

(72) Inventors: Matthew Weidman, Orlando, FL (US); Martin Richardson, Geneva, FL (US)

(73) Assignee: University of Central Florida Research Foundation Inc., Orlando, FL (US)

(21) Appl. No.: 14/164,849

(22) Filed: Jan. 27, 2014

Related U.S. Application Data
(60) Provisional application No. 61/756,559, filed on Jan. 25, 2013.

(51) Int. Cl. G02B 5/08; F21V 7/05

(52) U.S. Cl. CPC G02B 5/0808; F21V 7/05
USPC 362/259; 359/871

(57) ABSTRACT

Each of an optical component, a laser apparatus that includes the optical component and a method for operating the laser apparatus uses a particular reflective material layer located and formed over a substrate at a particular thickness for providing the optical component, the laser apparatus and the method for operating the laser apparatus with sufficient imperviousness to laser filaments under particular energy density fluence considerations. A particular reflective material layer comprises gold or a gold alloy. Other reflective materials may include silver, copper, aluminum and palladium reflective materials and related alloys.

### CROSS-REFERENCE TO RELATED APPLICATION

This application is related to, and derives priority from, U.S. Provisional Patent Application Ser. No. 61/756,559, filed 25 Jan. 2013 and titled Optical Component, Method and Application, the content of which is incorporated herein fully by reference.

### STATEMENT OF GOVERNMENT INTEREST

Not applicable.

### BACKGROUND

1. Field of the Invention

Embodiments relate generally to reflective optical components. More particularly embodiments relate to reflective optical components with enhanced performance.

2. Description of the Related Art

As optical device and optical component technology continues to advance so also does a need for optical devices and optical components with enhanced performance. Insofar as optical device and optical component technology advancements are unlikely to abate, desirable also are continued advances in optical device and optical component performance.

### SUMMARY

Embodiments relate to a reflective optical component (i.e., a mirror) that may be used within a laser apparatus. Embodiments relate also to the laser apparatus that includes the reflective optical component and a method for operating the laser apparatus that includes the reflective optical component.

Within the context of a particular embodiment, the reflective optical component comprises a sapphire (or other) substrate, in conjunction with, for the particular embodiment, a gold reflective material layer or gold alloy reflective material layer located and formed upon or over the sapphire (or other) substrate. Beyond the foregoing gold reflective material layer or gold alloy reflective material layer, other reflective material layers that may be used within the context of other embodiments include but are not limited to copper reflective material layers, silver reflective material layers, aluminum reflective material layers and palladium reflective material layers. As well, related alloys of any of the foregoing reflective materials may also be used in place of the gold reflective material layer or the gold alloy reflective material layer in accordance with the more specific embodiment.

In addition, an adhesive material layer, such as but not limited to a chromium adhesive material layer, may also be included interposed between the substrate and the reflective material layer as described above. As well, the reflective material layer may include an oxidation inhibiting material layer located and formed thereupon, which may include a thinner gold reflective material layer when the reflective material layer comprises other than a gold reflective material.

The gold reflective material layer or gold alloy reflective material layer within a reflective optical component in accordance with the embodiments has a thickness about 500 nm (i.e., from about 400 nm to about 600 nm) in a particular embodiment. Otherwise, the reflective material layer (that may include but is not limited to a more general embodiment of the gold reflective material layer) has a thickness from about 100 nm to about 10 um. A measured surface quality less than 50 nm over an area of 1 square mm is desirable for the reflective material layer within a reflective optical component in accordance with the embodiments.

The reflective optical component in accordance with the embodiments is particularly stable with respect to impingement by laser filaments with a wavelength centered around 800 nm, a description of which is included in conjunction with the Detailed Description of the Non-Limiting Embodiments. The reflective optical component in accordance with the embodiments is moreover stable with respect to impinging laser filaments as described above at a pulse energy at least about 10 mJ (i.e., from about 10 to about 20 mJ), an irradiance at least about 10e13 W/cm² (i.e., from about 10e13 to about 10e14 W/cm²) and a fluence at least about 0.62 J/cm² (i.e., from about 0.62 to about 0.92 J/cm²). Laser filament fluence characteristics are illustrated graphically in some detail in the accompanying FIG. 6, for reference purposes. Stability of the reflective optical component in accordance with the embodiments with respect to laser filaments may be assessed by absence of a variation (i.e., within measurement uncertainty) in surface quality as defined above upon impingement by a fixed number of laser filament shots, as determined experimentally. Given various applications, the reflective optical component in accordance with the embodiments may be a consumable component.

To form laser filaments in air requires an ultrashort pulse in a femtosecond to picosecond range. To form laser filaments also requires a pulse power in excess of a critical power, which is a power threshold that is dependent on a pulse duration, and will generally be in a gigawatt range.

A particular optical component in accordance with the embodiment includes a substrate. The particular optical component also includes a reflective material layer located over the substrate, where the reflective material layer reflects a laser filament and is not damaged when impinged by the laser filament at a pulse energy at least about 10 mJ, an irradiance at least about 10e13 W/cm² and a fluence at least about 0.62 J/cm².

A particular laser apparatus in accordance with the embodiments includes a lasing component that provides a laser filament having a pulse energy at least about 10 mJ, an irradiance at least about 10e13 W/cm² and a fluence at least about 0.62 J/cm². The particular laser apparatus also includes a reflective component upon which is incident the laser filament, the reflective component comprising a substrate and a reflective material layer that is not damaged by the laser filament.

A particular method for operating a laser apparatus in accordance with the embodiments includes providing a laser apparatus comprising: (1) a lasing component that provides a laser filament having a pulse energy at least about 10 mJ, an irradiance at least about 10e13 W/cm² and a fluence at least about 0.62 J/cm²; and (2) a reflective component comprising a substrate and a reflective material layer selected from the group consisting of gold, copper, silver, aluminum, palladium and alloys thereof formed over the substrate. The method for operating the laser apparatus also includes energizing the lasing component to provide the laser filament that impinges upon the reflective component.

### BRIEF DESCRIPTION OF THE DRAWINGS

The objects, features and advantages of the embodiments are understood within the context of the Detailed Description of the Non-Limiting Embodiments, as set forth below. The Detailed Description of the Non-Limiting Embodiments is understood within the context of the accompanying drawings, that form a material part of this disclosure, wherein:

FIG. 1 shows schematic perspective view diagram and a schematic cross-sectional view diagram of a reflective optical component gold mirror in accordance with the embodiments.

FIG. 2 shows a surface profile scan of a 500 nm thick gold layer located and formed upon a sapphire substrate and measured using a white-light interferometric microscope (WIM) (Newview, Zygo) apparatus in accordance with the embodiments. The surface roughness as measured was measured as 28 nm peak-to-peak (PTP) and as 6 nm root mean square (RMS).

FIG. 3 shows a scanning electron microscopy (SEM) image of the 500 nm thick gold layer located and formed upon the sapphire substrate following filament irradiation (insert shows a magnified zoomed-in view).

FIG. 4 shows a non-focused laser filament ablation, within a 50 m range, of gallium arsenide (a) after and (b) before reflection from a 500 nm gold layer in accordance with the embodiments. The gallium arsenide crater profiles (a) and (b) were evaluated over more than 20 single shot measurements and the average and standard deviation are given by the solid line and the shaded region, respectively. Diagrams (c) and (d) illustrate experimental apparatus configurations that correspond with measurements as illustrated in (a) and (b).

FIG. 5 shows a schematic illustration of laser filamentation dynamics. The dimensions shown are exaggerated to clearly illustrate the regimes of nonlinear propagation during the filamentation process which includes: (1) self-focusing leading to beam collapse; (2) the oscillation between focusing and defocusing; (3) stable filamentation; and (4) the discontinuation of filamentation, as progressing from left to right within FIG. 5.

FIG. 6 shows optical properties, including fluence, of a filamentous laser beam in accordance with the embodiments.

### DETAILED DESCRIPTION OF THE NON-LIMITING EMBODIMENTS

Embodiments include an optical component, a related laser apparatus that includes the optical component and a related method for operating the laser apparatus that includes the optical component. The optical component, the related laser apparatus and the related method for operating the laser apparatus each include specific material of construction requirements with respect to a substrate that comprises the optical component and a reflective material layer located and formed upon the substrate, and which also comprises the optical component.

1. General Considerations for an Optical Component in Accordance with the Embodiments

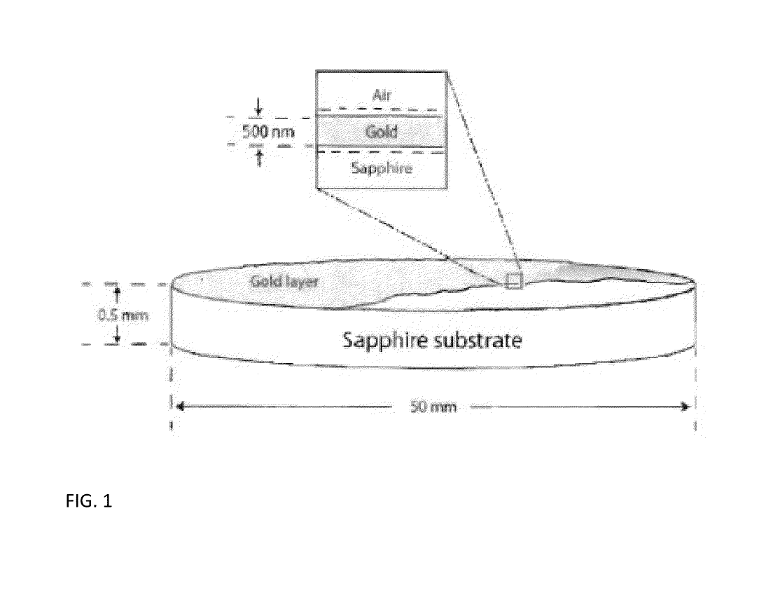

FIG. 1 shows an optical component in accordance with a particular embodiment. The optical component comprises a substrate (and in particular a sapphire substrate) having located and formed thereover and preferably thereupon a gold layer.

Within the context of the particular embodiment as illustrated, the sapphire substrate has a thickness from about 0.4 to about 0.6 mm and the gold layer has a thickness from about 400 to about 600 nm.

Although FIG. 1 illustrates a particular reflective optical component in accordance with the embodiments as comprising a sapphire substrate, the embodiments in general are not intended to be so limited. Rather within the context of the embodiments in general a usable substrate within an optical component in accordance with the embodiments in general may comprise a substrate material selected from the group including but not limited to a conductor substrate material, a semiconductor substrate material and a dielectric substrate material, provided that the conductor substrate material, the semiconductor substrate material or the dielectric substrate material has adequate adhesion with respect to a reflective material layer located and formed upon the substrate. Typically and preferably this alternative substrate in comparison with the sapphire substrate also has a thickness from about 0.4 to about 0.6 mm, consistent with the sapphire substrate as illustrated in FIG. 1.

Although FIG. 1 illustrates a particular reflective optical component in accordance with the embodiments as comprising a gold layer as a reflective layer, the embodiments are similarly also again not intended to be so limited. Rather, within the context of the embodiments in general, a usable reflective material layer with respect to the substrate may comprise a reflective material selected from the group including but not limited to a gold reflective material, a copper reflective material, a silver reflective material, an aluminum reflective material or a palladium reflective material, as well as an alloy that includes any one of more of the foregoing reflective materials. Within the context of the embodiments any of these alternative reflective material layers has a thickness from about 100 nm to about 10 um.

Also illustrated in phantom within the schematic cross-sectional diagram of FIG. 1 is an adhesion promotion layer interposed between the sapphire substrate and the gold layer. Within the context of the embodiments, the adhesion promotion layer comprises a chromium adhesion promotion material located and formed interposed between the sapphire substrate and the gold layer to a thickness from about 10 to about 100 nm, although other adhesion promotion materials, as well as thicknesses up to about 10 um, are not excluded.

Finally, also illustrated within the schematic cross-sectional diagram of FIG. 1 in phantom is an oxidation inhibition layer located and formed over and upon the gold layer (or more particularly an alternative reflective material when the gold layer comprises other than a gold material). Such an oxidation inhibition layer may comprise a gold material when the gold layer comprises other than a gold material. Typically and preferably, such an oxidation inhibition layer is located and formed upon the gold layer when comprised of other than the gold material to a thickness from about 10 to about 100 nm, although greater thicknesses of up to about 10 um are not excluded.

The reflective optical component whose schematic cross-sectional diagram is illustrated in FIG. 1 may be fabricated using any of several methods. Any of the several methods as well may use any of several different starting materials. Such methods may include, but are not necessarily limited to physical vapor deposition (PVD) methods such as but not limited to evaporative methods and sputtering methods, as well as chemical vapor deposition (CVD) methods.

2. Gold Mirror Engineered to Withstand the High Peak-Powers Associated with Laser Filaments

The optical component in accordance with a particular embodiment as described above consists of or comprises a 500 nanometer thick layer of high purity gold that is deposited on a smooth sapphire substrate.

A. Material Properties of Gold

As compared with transition metals such as titanium, there are several differences in the properties of gold as a reflective material layer that merit consideration with respect to use as a laser filament reflective mirror. In that regard, gold is a noble metal with a completely filled d-band (5d106s1) electron configuration, while within titanium, for comparison, the d-band is only partially filled (3d24s2). In addition, an electron-phonon coupling constant of gold is less than half that of titanium (i.e., 0.17 versus 0.38). Finally, for a wavelength of 800 nm, the reflectivity of gold is nearly twice the reflectivity of titanium.

A two-temperature model may be used to describe the observed linear dependence (up to nearly 500 nm) of the melting fluence threshold on the thickness of a gold reflective layer. Based on these results, it is suggested that femtosecond laser-induced damage of metals (i.e., such as but not limited to gold) is thermally driven. Using a two-temperature model, one may be able to show the temperature dynamics for both the electron and the lattice sub-systems for gold layers and for nickel layers. Gold, as an example of a noble metal, shows a much slower transfer of energy between electron and lattice sub-systems as compared with nickel, a transition metal. Because of this slow decay in electron temperature, these hot electrons penetrate into a material well beyond the skin depth of the material, and at velocities around 10e6 m/s. Therefore, the temperature of the backside of a 100 nm thick gold layer closely tracks that of the front surface of the 100 nm thick gold layer. For a nickel layer, however, there is a significant temperature difference between the front layer surface and the back layer surface.

While the forgoing discussion is directed towards a gold layer located and formed upon a sapphire substrate for purposes of enhanced reflection of filamentous laser irradiation, the embodiments in general are not intended to be so limited. Rather the embodiments also consider the possibility of creating a similar reflective optical component mirror while using a neighboring element in the periodic table with a similarly high electron mobility and an intrinsic reflectivity in the infrared radiation region. Such neighboring elements may include, but are not necessarily limited to copper, silver, aluminum and palladium, and related alloys including at least one of copper, silver, aluminum and palladium.

B. A Prototype Optically Reflective Optical Component Minor

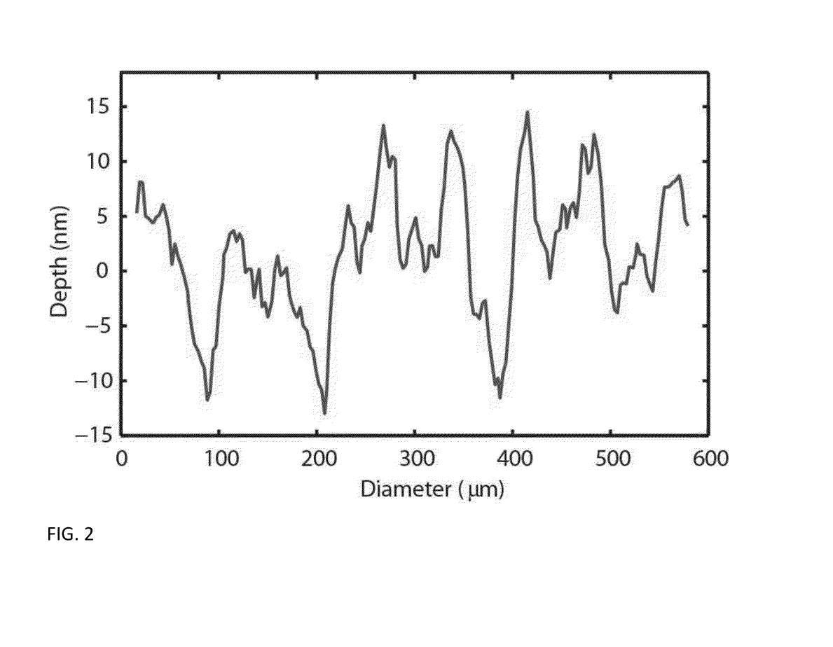

A prototype reflective optical component minor was fabricated by depositing a 500 nm thick layer of 99.99999% pure gold upon a sapphire substrate using a thermal evaporator. See again, e.g., FIG. 1. The resulting gold surface has root-mean-square (RMS) and peak-to-peak (PTP) roughness of 6 nm and 28 nm, respectively. See again, e.g., FIG. 2. For applications involving an 800 nm femtosecond laser system, this RMS surface roughness is 100 times smaller than the wavelength.

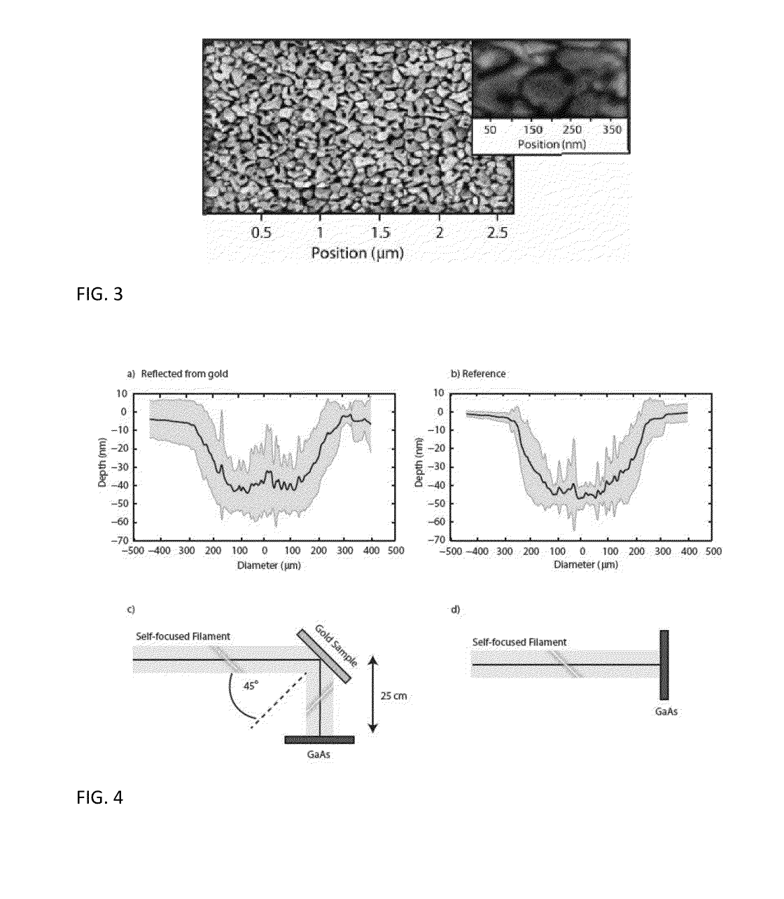

The 500 nm thick gold layer deposited upon the sapphire substrate was observed to have reflected an incident laser filament, and no ablation was observed. See, e.g., FIG. 3. Thus, the filament fluence did not exceed the gold layer material damage threshold.

For testing, a prototype reflective optical component gold minor was mounted 45 degrees to an incident filament axis as illustrated in FIG. 4C. The reflected beam had sufficient irradiance to ablate a GaAs target. The application of the gold minor prototype as a “filament mirror” was demonstrated for the case of a non-focused filament at a position of 45 m from the laser. The repeated irradiation up to tens of shots, in the same location on the gold surface was also successful in causing no noticeable modification.

C. Maximum Fluence on Reflective Optical Component Gold Mirror Before Damage Occurs

Gold is a commonly used material, because of its high reflectivity in the infrared, and thus gold has been the subject of many investigations. For example, the ultrashort-pulse damage of gold coated compressor gratings, commonly used in CPA laser systems, has been investigated using a 1053 nm 300 fs laser system. The multi-shot fluence threshold was about 0.6 J/cm² for a 500 nm thick gold coated mirror that was irradiated at normal incidence. Related modeling work suggested that melting of a 1 μm thick gold film would occur for an incident fluence of 0.93 J/cm². Based upon modeling results, also suggested is a temperature dependence of the electron heat capacity and electron-phonon coupling for both titanium and for gold.

Others have also observed the formation of nanostructure-covered large scale waves (NC-LSWs) on a gold foil irradiated with tens of pulses from an 800 nm 65 fs laser with a focused fluence of 0.53 J/cm². Still others have observed the formation of nanojets and micro-bubbles on a 60 nm thick gold film fabricated using magnetron sputtering. A bump-like structure occurred for fluences above 0.5 J/cm² and a jet-like feature was observed for fluences above 1.1 J/cm². It is suggested that the formation of these features was possible because of the slow increase in lattice temperature that corresponded to a longer lasting molten stage. These results were later modeled and found that these nano-structures were unique to gold because of properties such as yield stress and the elastic characteristics.

For laser filaments incident on gold layer surfaces, the lack of observed modification, as illustrated in FIG. 3, is consistent with below threshold irradiation. An estimated peak filament fluence, in the range of 622-934 mJ/cm², exceeds a range of threshold values reported in the literature for fs laser ablation of gold. The high purity (99.99999%) and high degree of surface smoothness (RMS roughness of 6 nm of the gold mirror used in this work) was likely superior to what has commonly been reported in the literature. In contrast to focused fs melting and/or ablation of gold, the larger diameter fluence profile associated with a non-focused filament corresponded to a weaker fluence gradient which is potentially advantageous for avoiding filament-induced damage.

3. Background Information Regarding Laser Filaments

Filamentation is a form of non-linear laser light propagation that allows a laser light beam to propagate without increasing in diameter. In that regard, it has been proposed that a filament be defined as “the propagation zone where there is intensity clamping.” Laser light filamentation requires a nonlinear medium and results from a dynamic balance between self-focusing and defocusing mechanisms such as diffraction and plasma defocusing.

Laser light filamentation begins with self-focusing within a nonlinear medium that results from an intensity dependent and spatially varying refractive index profile. To first order, the nonlinear refractive index profile experienced by an intense laser pulse is given by:

n=n₀+n₂I(r,t)

where n is the total refractive index, no is the linear component of the refractive index and n2 is the nonlinear component that is proportional to the spatially (r) and temporally (t) varying laser irradiance, I(r,t). Because the non-linear refractive index, nz, is only 5.6·10e−19 cm²/W for air at atmospheric pressure and at 300 K, this non-linear effect is most apparent for high peak power ultrashort laser pulses. A pulse with a Gaussian shaped spatial intensity distribution will experience a Gaussian shaped refractive index profile, e.g., a refractive index profile that is highest on-axis. This refractive index distribution acts as a positive lens that causes the beam to self focus.

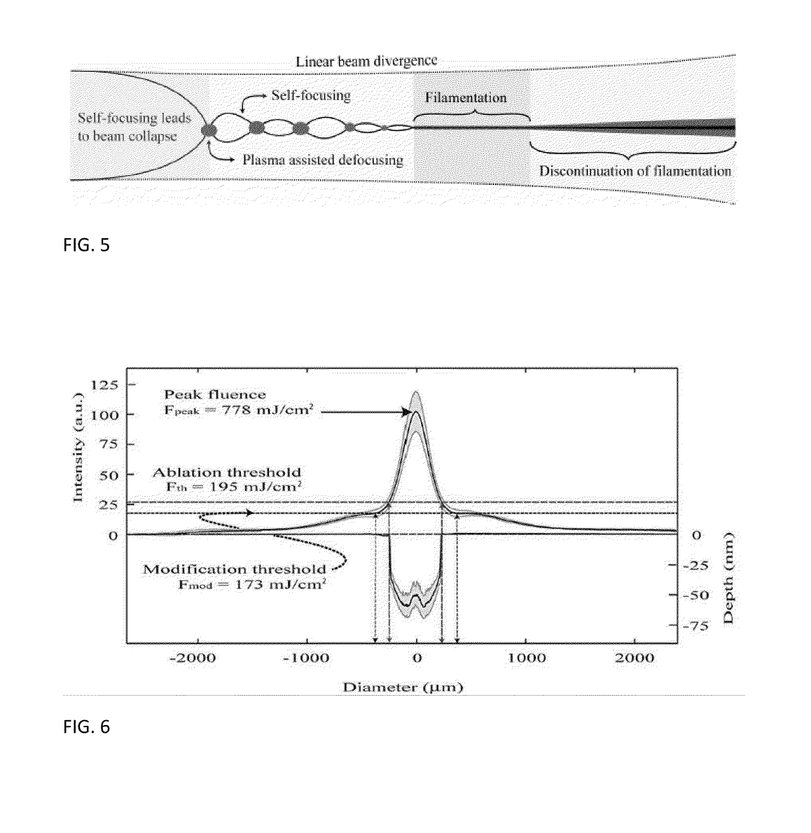

Self-focusing causes the beam to collapse when the pulse power exceeds the critical power threshold for the medium and the beam divergence from diffraction is overcome. Following beam self-focusing and collapse, the spatial intensity distribution becomes a ‘Townes’ spatial profile, as depicted by the schematic illustration in FIG. 5.

Self-focusing increases the irradiance until ionization of the medium occurs and an under dense plasma is formed. The plasma contributes negatively to the refractive index and, along with other mechanisms such as diffraction, will cancel the effects of self focusing and lead to the formation of a filament as illustrated in FIG. 5. During the onset of filamentation, oscillation between focusing and defocusing mechanisms can modulate both the spatial extent of the filament as well as the irradiance. Following this region of oscillation, the filament stabilizes, as illustrated in FIG. 5. The stable filament is composed of an intense core with clamped irradiance that is surrounded by an energy reservoir. For filamentation in air, the clamped core irradiance, on the order of 7·10e13 W/cm², results in the ionization of oxygen and nitrogen and the formation of an underdense plasma. The filamentation region that is accompanied by plasma is followed by a less intense region where diffraction is partially compensated by self focusing.

All references, including publications, patent applications, and patents cited herein are hereby incorporated by reference in their entireties to the same extent as if each reference was individually and specifically indicated to be incorporated by reference and was set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it was individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. An optical component comprising:
a substrate; and
a reflective material layer located over the substrate, where the reflective material layer reflects a laser filament and is not damaged when impinged by the laser filament at a pulse energy at least about 10 mJ, an irradiance at least about 10e13 W/cm² and a fluence at least about 0.62 J/cm².

2. The optical component of claim 1 wherein the optical component comprises a mirror.

3. The optical component of claim 1 wherein the substrate comprises a sapphire substrate.

4. The optical component of claim 1 wherein the reflective material layer comprises a gold reflective material or a gold alloy reflective material.

5. The optical component of claim 4 wherein the reflective material layer has a thickness from about 100 nm to about 10 um.

6. The optical component of claim 1 wherein the reflective material layer comprises a reflective material selected from the group consisting of copper reflective materials, silver reflective material, aluminum reflective materials and palladium reflective materials, and alloys of copper reflective materials, silver reflective materials, aluminum reflective materials and palladium reflective materials.

7. The optical component of claim 6 wherein the reflective material layer has a thickness from about 100 nm to about 10 um.

8. The optical component of claim 1 wherein the optical component further comprises an adhesion promotion layer located interposed between the substrate and the reflective material layer.

9. The optical component of claim 8 wherein the adhesion promotion layer comprises a chromium adhesion promotion material.

10. The optical component of claim 1 wherein the optical component further comprises an oxidation inhibition layer located upon the reflective material layer.

11. A laser apparatus comprising:
a lasing component that provides a laser filament having a pulse energy at least about 10 mJ, an irradiance at least about 10e13 W/cm² and a fluence at least about 0.62 J/cm²; and
a reflective component upon which is incident the laser filament, the reflective component comprising a substrate and a reflective material layer that is not damaged by the laser filament.

12. The laser apparatus of claim 11 wherein the substrate comprises a sapphire substrate.

13. The laser apparatus of claim 11 wherein the reflective material layer comprises a gold reflective material.

14. The laser apparatus of claim 13 wherein the reflective material layer has a thickness from about 100 nm to about 10 um.

15. The laser apparatus of claim 11 wherein the reflective material layer comprises a reflective material selected from the group consisting of silver reflective materials, copper reflective materials, aluminum reflective materials, palladium reflective material and alloys of silver reflective materials, copper reflective materials, aluminum reflective materials and palladium reflective materials.

16. The laser apparatus of claim 15 wherein the reflective material layer has a thickness from about 100 nm to about 10 um.

17. A method for operating a laser apparatus comprising:
providing a laser apparatus comprising:
a lasing component that provides a laser filament having a pulse energy at least about 10 mJ, an irradiance at least about 10e13 W/cm² and a fluence at least about 0.62 J/cm²; and
a reflective component comprising a substrate and a reflective material layer selected from the group consisting of gold, silver, copper, aluminum, palladium and alloys thereof formed over the substrate; and
energizing the lasing component to provide the laser filament that impinges upon the reflective component.

18. The method of claim 17 wherein:
the substrate comprises a sapphire substrate; and
the reflective material layer comprises a gold reflective material or a gold alloy reflective material.

19. The method of claim 17 wherein the reflective material layer comprises a reflective material selected from the group consisting of silver reflective materials, copper reflective materials, aluminum reflective materials and palladium reflective materials, and alloys of silver reflective materials, copper reflective materials, aluminum reflective materials and palladium reflective materials.

20. The method of claim 19 wherein the reflective material layer has a thickness from about 100 nm to about 10 um.
